(19) United States
(12) Patent Application Publication
(10) Pub. No.: US 2013/0208797 A1
(43) Pub. Date: Aug. 15, 2013

(54) IMAGE ENCODING/DECODING SYSTEM AND ASSOCIATED METHOD

(71) Applicant: Novatek Microelectronics Corp., (US)

(72) Inventors: Ying-Hung LU, Kaohsiung City (TW); Yu-Wei CHANG, Hsinchu City (TW)

(73) Assignee: NOVATEK MICROELECTRONICS CORP., Hsinchu (TW)

(21) Appl. No.: 13/667,509

(22) Filed: Nov. 2, 2012

(30) Foreign Application Priority Data
Feb. 15, 2012 (TW) 101104981

(51) Int. Cl. H04N 7/26; H04N 7/32

(52) U.S. Cl. 375/240.16; 375/240.01; 375/240.25; 375/E07.026; 375/E07.243

(57) ABSTRACT

An image encoding system includes: a main encoding unit, including a binarization unit, for encoding/compressing a source data into a binary string and outputting side information; a first storage unit, for buffering the binary string generated by the main encoding unit; a second storage unit, buffering the side information generated by the main encoding unit; and a binary arithmetic coding (BAC) encoding unit, coupled to the first and second storage units, for encoding the binary string into a bitstream with reference to the side information and for outputting the bitstream.

This application claims the benefit of Taiwan application Serial No. 101104981, filed Feb. 15, 2012, the subject matter of which is incorporated herein by reference.

### BACKGROUND OF THE INVENTION

1. Technical Field

The disclosure relates to an image encoding/decoding system and associated method.

2. Description of the Related Art

As the public ceaselessly pursue superior image quality, the data size and the resolution of image data are significantly increased. Moreover, image compression techniques also develop at an overwhelmingly fast speed to target at better transmitting and storing compressed high-definition image data. In many image compression systems, entropy coding compresses data in a reasonable manner through a probability table, and is considered an essential compression technique in the related field. In entropy coding, a most popular form is Huffman coding, which encodes data through constructing a Huffman tree on basis of specific probabilities. However, such coding form, as each symbol is represented by several bits, does not quite reach an ultimate compression rate.

To overcome drawbacks of the above approach, arithmetic coding is developed. The arithmetic coding has numerous forms including binary arithmetic coding. The binary arithmetic coding is prevalent in image compression systems, and includes well-known H.264 context-based adaptive binary arithmetic coding (CABAC) and VP8 tree coding.

Taking CABAC for example, a basic compression process of the CABAC includes two parts—binarization, and binary arithmetic coding (BAC). In binarization, a syntax element generated during the compression process is converted to a binary string consisted of 1 and 0. For example, after two values 5 and 7 undergoing U-binarization, 111110 and 11111110 binary strings are respectively generated. The two binary strings are connected into 11111011111110 as a binarization result. The above approach is given as an example of binarization in the CABAC, and other binarization approaches in the CABAC are to known to a person having ordinary skill in the art, and details thereof shall be omitted herein. A binary string generated from the BAC is converted to a bitstream. In a computation process of the BAC, only one binary value is consumed in each coding cycle due to data dependency.

It is known from the above descriptions that, from perspectives of hardware, throughput of binarization is far greater than that of the BAC due to data dependency of the BAC. In a binarization process, one or more binary values can be generated in one cycle from one syntax element through a look-up table. However, only one binary value can be processed in one cycle with the BAC. As a result, in a current solution, the number of binary values that can be processed in one hardware cycle is limited. It is apparent that a bottleneck of a BAC encoding/decoding system is the throughput of the BAC encoding/decoding.

### SUMMARY OF THE DISCLOSURE

The disclosure is directed to an image encoding/decoding system and associated method for disengaging entropy coding from pipelined operations.

According to an embodiment the present disclosure, an image encoding system is provided. The image encoding system includes: a main encoding unit, including a binarization unit, for encoding/compressing a source data to output a binary string and outputting side information; a first storage unit, for buffering the binary string generated by the main encoding unit; a second storage unit, for buffering the side information generated by the main encoding unit; and a binary arithmetic coding (BAC) encoding unit, for converting the binary string to a bitstream with reference to the side information and for outputting the bitstream.

According to another embodiment of the present disclosure, an image decoding system is provided. The image decoding system includes: a BAC decoding unit, for decoding a bitstream to a binary string and side information; a first storage unit, for buffering the binary string generated by the BAC decoding unit; a second storage unit, for buffering the side information generated by the BAC decoding unit; and a main decoding unit, including a de-binarization unit, for decoding the binary string with reference to the side information to generate an output image signal.

According to another embodiment of the present disclosure, an image encoding method is provided. The method includes steps of: encoding/compressing a source data to output a binary string, outputting side information according to the source data, buffering the binary string, buffering the side information, and converting the binary string to a bitstream with reference to the side information and outputting the bitstream.

According to yet another embodiment of the present disclosure, an image decoding method is provided. The method includes steps of: decoding a bitstream to a binary string and side information, buffering the binary string, buffering the side information, and decoding the binary string with reference to the side information to generate an output image signal.

The above and other contents of the disclosure will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an image encoding system according to an embodiment of the disclosure.

FIG. 2 is a block diagram of a main encoding unit of an image encoding system according to an embodiment of the disclosure.

FIG. 3A (PRIOR ART) is a schematic diagram of pipelined encoding operations of a conventional encoding system (having a small memory) in the prior art.

FIG. 3B is a schematic diagram of pipelined encoding operations of an image encoding system (having a small memory) according to an embodiment of the disclosure.

FIG. 4A is a schematic diagram of pipelined encoding operations of a conventional encoding system (having a large memory) in the prior art.

FIG. 4B is a schematic diagram of pipelined encoding operations of an image encoding system (having a large memory) according to an embodiment of the disclosure.

FIG. 5 is a block diagram of an image encoding system according to another embodiment of the disclosure.

### DETAILED DESCRIPTION OF THE DISCLOSURE

In embodiments of the present disclosure, to increase efficiency and to solve an issue caused by macro-block pipeline scheduling, entropy coding is disengaged from the macro-block pipeline scheduling. For illustration purposes, in the embodiments below, an H.264-compliant image encoding system is taken as an example rather than a limitation to the present disclosure. A person having ordinary skill in the art can easily modify and apply the embodiments of the present disclosure to other image encoding/decoding systems of different specifications based on disclosed contents of the embodiments, and such modifications and applications are also encompassed within the scope of the present disclosure.

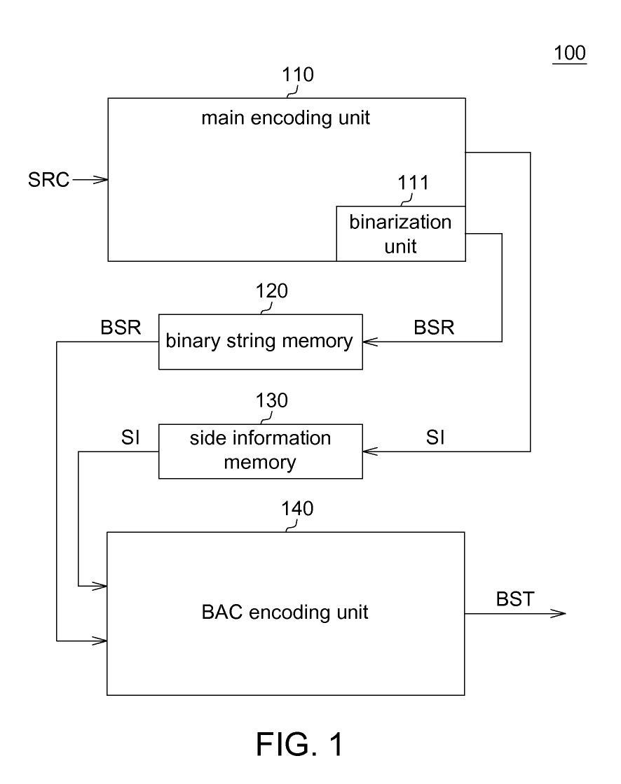

FIG. 1 shows a block diagram of an image encoding system 100 according to an embodiment of the disclosure. An image encoding system 100 includes a main encoding unit 110, a binary string memory 120, a side information memory 130, and a binary arithmetic coding (BAC) encoding unit 140. The main encoding unit 110 includes a binarization unit 111. The image encoding system 100 implements BAC.

The main encoding unit 110 encodes a source data SRC, and outputs a binary string BSR. Based on different image encoding/decoding specifications, a main structure and operations of the main encoding unit 110 may differ.

The binary string memory 120 buffers the binary string BSR generated by the main encoding unit 110, and outputs the buffered binary string BSR to the BAC encoding unit 140.

The side information memory 130 buffers side information SI generated by the main encoding unit 110, and outputs the buffered side information SI to the BAC encoding unit 140. The side information memory 130 stores information required for decoding.

For example, in H.264, the BAC process begins from a macro-block header. Thus, the BAC encoding unit 140 may only have information located after the macro-block header with respect to decoded information generated from decoding the binary string BSR. To successfully perform the decoding or encoding process, information located before the macro-block header is needed, e.g., a slice header, a picture parameter set (PPS), and/or a sequence parameter set (SPS)—such information is referred to as side information and is stored in the side information memory 130. In H.264, the PPS and the SPS are important parameter sets. The PPS includes all segment information in a same picture, and the SPS includes information associated with picture sequencing.

The BAC encoding unit 140 converts the binary string BSR to a bitstream BST with reference to the side information SI.

In this embodiment, in FIG. 1, the binary string memory 120 and the side information memory 130 are shown as external memories of the main encoding unit 110 as an example. It should be noted that, in an alternative embodiment, the binary string memory 120 and/or the side information memory 130 may be an internal memory of the main encoding unit 110, as such modification is encompassed within the spirit of the disclosure.

More specifically, when performing the encoding (compression) process, instead of directly obtaining the bitstream BST by the main encoding unit 110, the source data is first converted to the binary string BSR by the main encoding unit 110. The main encoding unit 110 respectively sends the binary string BSR and the side information SI to the binary string memory 120 and the side information memory 130, and continues with the encoding process. The conversion from the binary string BSR to the bitstream BST is performed by the BAC encoding unit 140.

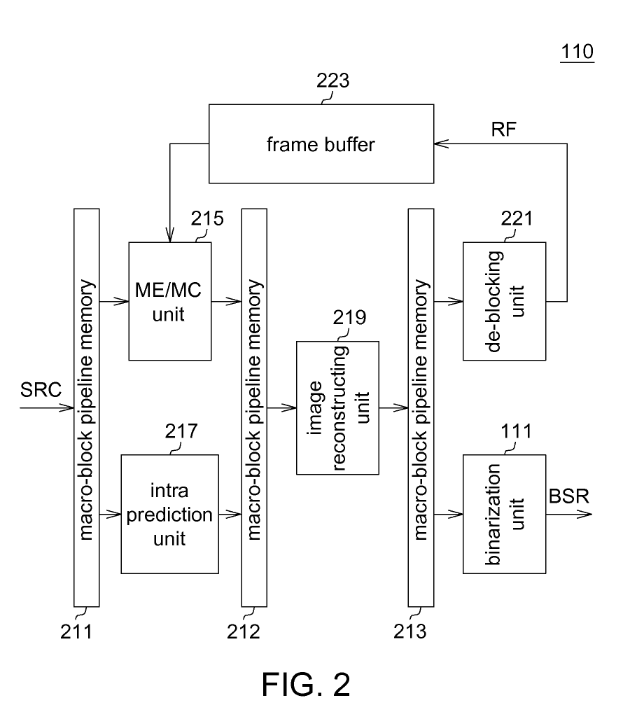

FIG. 2 shows a block diagram of the main encoding unit 110 of the image encoding system 100 according to an embodiment. In the embodiment, for entropy coding, the main encoding unit 110 outputs the binary string BST obtained from binarization of the source data and the side information SI needed for encoding to the memories 120 and 130, respectively. In FIG. 2, an H.264-compliant image encoding system is taken as an example rather than a limitation to the present disclosure. A person having ordinary skill in the art can easily modify and apply the embodiments of the present disclosure to other image compression/encoding system in different specifications based on the spirit, scope and disclosed contents of the embodiments, and such modifications and applications are also encompassed within the scope of the present disclosure. Further, FIG. 2 is based on a macro-block pipeline structure that is also an example but not a limitation to the present disclosure.

The main encoding unit 110 includes a binarization unit 111, macro-block pipeline memories 211 to 213, a motion estimation/motion calculation (ME/MC) unit 215, an intra prediction unit 217, an image reconstructing unit 219, a de-blocking unit 221, and a frame buffer 223.

The macro-block pipeline memories 211 to 213 are for buffering data during the process of macro-block pipelined scheduling performed by the main encoding unit 110. Since a macro-block pipeline structure is illustrated in this embodiment, the macro-block pipeline memories 211 to 213 are arranged between the units 215, 127, 219 and 221. The macro-block pipeline memories 211 to 213 are shared, meaning that under such structure, a next macro block can only be compressed after all the units completes tasks of a current macro block due to data dependency.

The ME/MC unit 215 may reduce temporal redundancy between frames. Based on correlations between successive frames, motion vectors between successive frames may be identified through block matching. The motion vectors are then encoded and sent to a rear end.

In image compression, a so-called “frame” includes a back scene and an object scene. The back scene and the object scene are divided by a image compressor into macro blocks having a predetermined size according to positions of the back scene and the object scene, and the macro blocks are compressed. Common themes in image are nature objects, and so many frames have quite monochromatic back scene and few objects. A monochromatic back scene implies that neighboring macro blocks of the back scene likely have similar pixel values, and also that neighboring macro blocks in the object scene have similar pixel values. Neighboring macro blocks in the frame also have similar pixel values. Hence, the technique for increasing a compression rate through searching, comparing and removing similarities between macro blocks is referred to as intra prediction encoding. Intra prediction means that predictions are according to different angles based on neighboring known (decoded) pixels.

The image reconstructing unit 219 reconstructs an image frame according to a result of the ME/MC unit 215 and a result of the intra prediction unit 217.

The de-blocking unit 221 eliminates possible mosaic generated in the reconstructed image frame from the reconstruction unit 219 during compression/encoding in order to provide standard image quality.

The de-blocked frame by the de-blocking unit 221 is buffered in the frame buffer 223. The frame in the frame buffer 223 is inputted to the ME/MC unit 215 to serve as a reference image for block matching.

The binarization unit 111 encodes and binarizes the result outputted by the image reconstructing unit 219 and header information needed for encoding. Further, the binarization unit 111 outputs the header information to the side information memory 130, and outputs the binarization result to the binary string memory 120 to complete the encoding process.

In this embodiment, operations in the main encoding unit 110 are pipelined but the BAC encoding operations are not pipelined. Such approach offers several benefits. First of all, like a look-up table, the binarization approach does not consume a large amount time and thus does not burden the compression system. Secondly, the BAC generally has the largest workload. In this embodiment, by designing the BAC in another module (i.e., the BAC encoding unit 140 outside the main encoding unit 110), efficiency of the BAC can be maximized. A reason behind such design is that, from perspectives of hardware design, it is desired that operation time consumed by all units is approximate or even the same, so that overall performance is not degraded if one unit consumes long operation time than other units. In processing special contents, non-homogeneous bin distribution may occur to cause a great difference in operation time consumed by the BAC when the BAC compressing the macro blocks—as the operation time for compressing some macro blocks may be extremely short whereas the operation time for compressing other macro blocks may be extremely long. Such phenomenon has a deadly influence on a macro-block pipeline structure. Therefore, it is probable that the system performance can be increased given that the above phenomenon is eliminated. Moreover, the compression rate of converting the binary string BSR to the bitstream BST ranges between one to four, meaning that a data rate of the binary string BSR is one to four times of that of the bitstream BST. Therefore, the binary string memory 120 may require a small bandwidth or a small size.

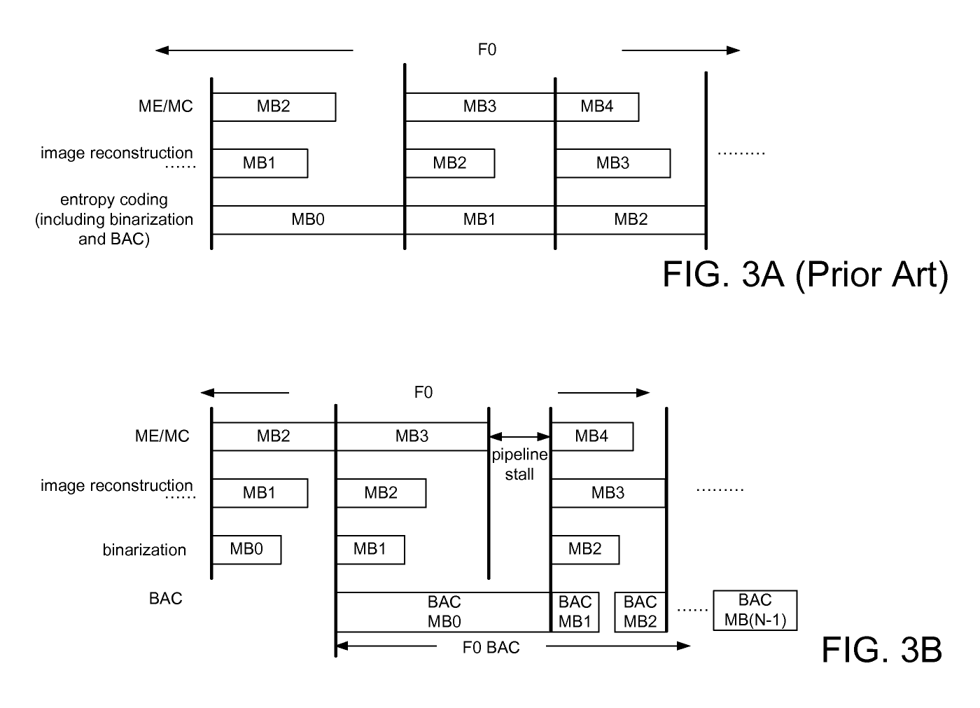

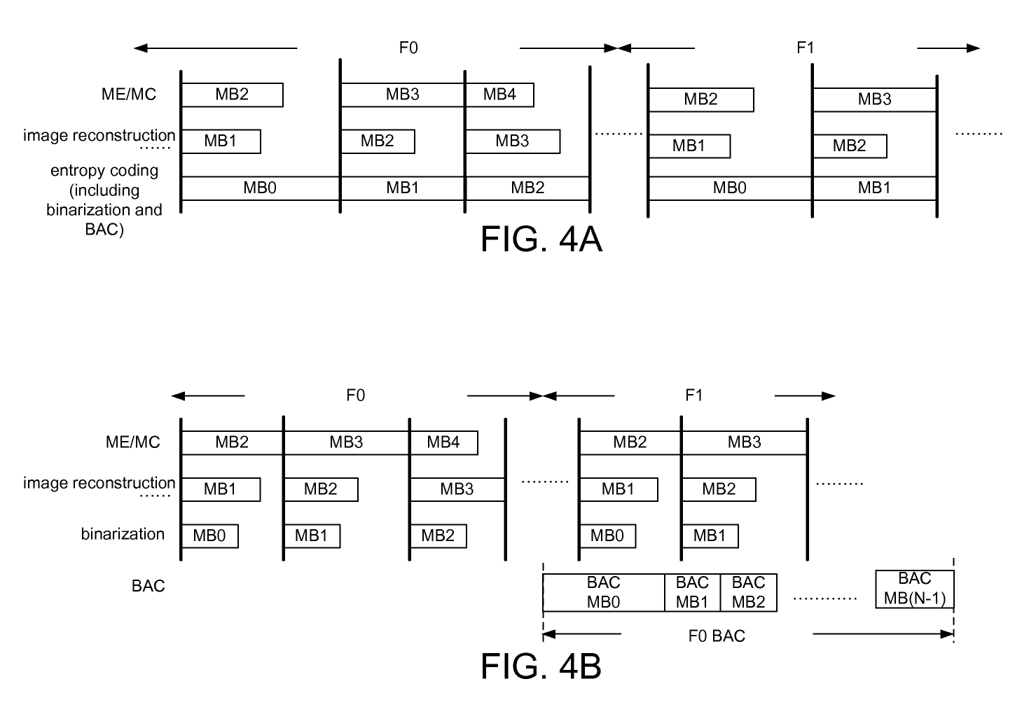

Advantages of the embodiment of the disclosure over a conventional solution are given below. FIG. 3A shows pipelined operations of an encoding process performed by a conventional encoding system (having a small memory) in the prior art. FIG. 3B shows pipelined operations of an encoding process performed by an image encoding system (having a small memory) according to an embodiment of the present disclosure. FIG. 4A shows pipelined operations of an encoding process performed by a conventional encoding system (having a large memory) in the prior art. FIG. 4B shows pipelined operations of an encoding process performed by an image encoding system (having a large memory) according to an embodiment of the present disclosure.

Referring to FIG. 3A and FIG. 3B. FIG. 3A shows a conventional structure. Entropy coding includes binarization and BAC. That is, the entropy coding is only considered complete when both the binarization and the BAC are complete. Therefore, as observed from FIG. 3A, the entropy coding affects the completion of the entire conventional image encoding process.

Again referring to FIG. 2, the main encoding unit 110 includes a four-stage pipeline structure—a first stage receiving data source SRC, a second stage including the ME/MC unit 215 and the intra prediction unit 217, a third stage including the image reconstructing unit 219, and a fourth stage including the de-blocking block 221 and the binarization unit 111. Referring to FIG. 3B showing the image encoding system according to the embodiment, the binarization and the BAC are separately and individually performed. As the entropy coding processes a 0^{th} macro block MB0 of a 0^{th} frame F0, the image reconstructing unit 219 processes a 1^{st} macro block MB1 of the 0^{th} frame F0, and the ME/MC unit 215 and the intra prediction unit 219 process a 2^{nd} macro block MB2 of the 0^{th} frame F0.

On basis of pipelined scheduling, a current macro block is only fully processed when a unit consuming a longest operation time in processing the current macroblock completes processing. Referring to FIG. 3A, in the pipelined scheduling on the 0^{th} macro block MB0, the entropy coding takes the longest operation time, meaning that all other units are only allowed to continue in processing a next macro block MB1 when the entropy coding on the 0^{th} macro block MB0 is complete, and so forth.

Referring to FIG. 3B, in this embodiment, assume that the binary string memory 120 and the side information memory 130 have small space. In the embodiment, the entropy coding is divided into two independent stages, the binarization unit 111 and the BAC encoding unit 140. Therefore, in the embodiment, after the binarization finishes, the binarization result and the side information are respectively stored to the binary string memory 120 and the side information memory 130, and the pipelined scheduling may start processing a next macro block. The BAC encoding unit 140 fetches data from the binary string memory 120 and from the side information memory 130 for BAC encoding. Therefore, it is clearly observed from FIG. 3B that the operation time needed for encoding is noticeably reduced.

However, in the embodiment, the binary string memory 120 and the side information memory 130 are small-space, occasional pipeline stalls may be incurred. As shown in FIG. 3B, the processing time of the BAC encoding for the macro blocks is intermittent. That is, only when the previous stage (the binarization unit) sends data, the BAC encoding unit 140 can then perform BAC encoding. Thus, in a situation of small-space memories, the embodiment of the disclosure may somewhat be affected by the pipelined scheduling. Nonetheless, an overall encoding speed is still much preferred than the conventional solution despite that the binary string memory 120 and the side information memory 130 are small-space.

FIGS. 4A and 4B are similar to FIGS. 3A and 3B. However, FIGS. 4A and 4B shows pipeline scheduling when large space memories (e.g., the binary string memory 120 and the side information memory 130) are employed. Assuming that the binary string memory 120 and the side information memory 130 have space sufficient for storing information of a whole frame, in the embodiment, the BAC encoding unit 140 encodes the 0^{th} frame F0 while the main encoding unit 110 encodes a 1^{St} frame F1. That is to say, the main encoding unit 110 and the BAC encoding unit 140 do not mutually affect processes of each other. Thus, an encoding capability of the BAC encoding is fully exercised and may be not possibly stalled due to the pipelined scheduling. As shown in FIG. 4B, the processing time of the BAC encoding unit 140 for macro blocks MB0 to MB(N−1) (where N is a positive integer) is continuous. Under such situation, the encoding efficient is better than that when employing the binary string memory 120 and the side information 130 having small capacities in FIG. 3B.

Therefore, it is demonstrated from the above descriptions that, regardless of large-size memories or small-size memories employed, the embodiments of the disclosure offer great improvements over the conventional solution.

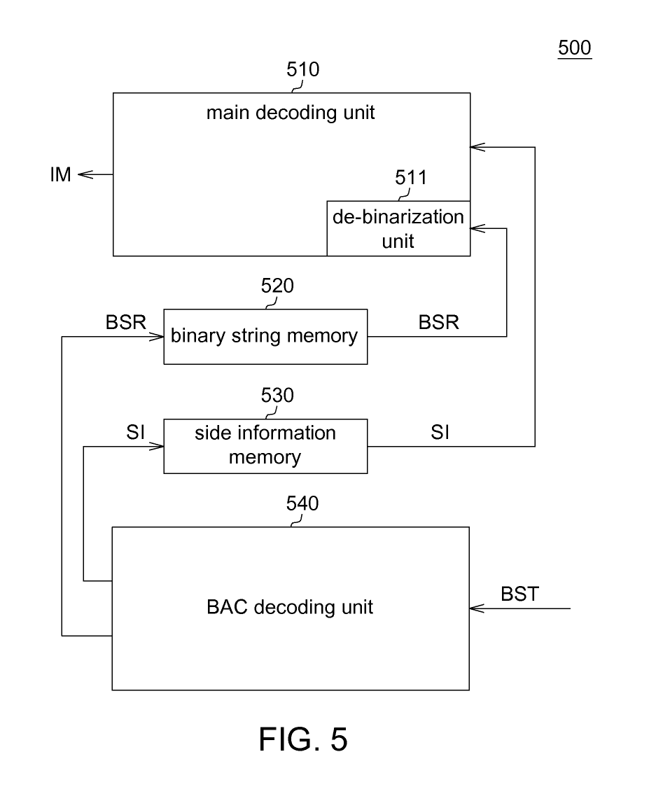

An image decoding system based on BAC according to another embodiment of the present disclosure is provided based on identical/similar principles as above. FIG. 5 shows a block diagram of an image decoding system 500 according to another embodiment of the present disclosure.

Referring to FIG. 5, the image decoding system 500 includes a main decoding unit 510 including a de-binarization unit 511, a binary string memory 520, a side information memory 530, and a BAC decoding unit 540.

The BAC decoding unit 540 decodes a bitstream BST to a binary string BSR and side information SI. The binary string memory 520 buffers the binary string BSR generated by the BAC decoding unit 540. The side information buffer 530 buffers the side information SI generated by the BAC decoding unit 540. The main decoding unit 510 decodes the binary string BSR with reference to the side information SI to generate an output image signal IM.

The image decoding system 500 in FIG. 5 has a reverse data flow of that of the image encoding system 100 in FIG. 1, and associated details shall be omitted herein.

In an alternative embodiment, the binarization/de-binarization unit may be independently provided outside the main encoding/decoding unit. That is to say, in the image encoding/decoding process, the operation of the binarization/de-binarization may also disengage from the pipelined scheduling.

The above embodiments of the present disclosure may also be applied to electronic devices such as digital television and MP4 players implementing image encoding/decoding techniques.

In the present disclosure, for example, the main encoding/decoding unit (and the internal components) and the BAC encoding/decoding unit may be implemented by a processing unit, a digital signal processing unit, a digital video processing unit, or a programmable integrated circuit such as a microcontroller, a field programmable gate array (FPGA), and designed by a hardware description language (HDL).

Further, the function elements in the above embodiments may also be implemented by software applications. For example, the applications may be recorded in a memory medium such as a read-only memory (ROM), a random access memory (RAM), an optical recording memory, a magnetic recording memory, or another type of recording memory. Alternatively, the function elements of the above embodiments may also be implemented by firmware. A computational processing unit may access and execute the applications of the embodiments of the present disclosure from a memory medium storing the applications to implement the above embodiments. Further, the above embodiments of the present disclosure may be implemented by a combination of hardware and software.

While the disclosure has been described by way of example and in terms of the preferred embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image encoding system, comprising:
a main encoding unit, comprising a binarization unit, for encoding/compressing a source data to output a binary string and outputting side information;
a first storage unit, for buffering the binary string generated by the main encoding unit;
a second storage unit, for buffering the side information generating by the main encoding unit; and
a binary arithmetic coding (BAC) encoding unit, coupled to the first and second storage units, for converting the binary string to a bitstream with reference to the side information and for outputting the bitstream.

2. The image encoding system according to claim 1, wherein the main encoding unit encodes/compresses the source data by pipelined scheduling to output the binary string; and the BAC encoding unit converts the binary string to the bitstream by non-pipelined scheduling.

3. The image encoding system according to claim 1, wherein the side information comprises slice header information, picture parameter set information, and/or sequence parameter set information.

4. The image encoding system according to claim 1, wherein the first and second storage units are external or internal to the main encoding unit.

5. The image encoding system according to claim 1, wherein the main encoding unit:
identifies a motion vector of the source data by block matching and encodes the motion vector;
searches, compares and eliminates similarities between a plurality of macro blocks of the source data by intra prediction;
reconstructs an image frame; and
eliminates a mosaic noise in a reconstructed image frame.

6. An image decoding system, comprising:
a BAC decoding unit, for decoding a bitstream to a binary string and side information;
a first storage unit, for buffering the binary string generated by the BAC decoding unit;
a second storage unit, for buffering the side information generated by the BAC decoding unit; and
a main decoding unit, comprising a de-binarization unit, for decoding the binary string with reference to the side information to generate an output image signal.

7. The image decoding system according to claim 6, wherein the main decoding unit decodes the binary string by pipelined scheduling; and the BAC decoding unit decodes the bitstream to the binary string by non-pipelined scheduling.

8. The image decoding system according to claim 6, wherein the side information comprises slice header information, picture parameter set information, and/or sequence parameter set information.

9. The image decoding system according to claim 6, wherein the first and second storage units are external or internal to the main decoding unit.

10. An image encoding method, comprising:
encoding/compressing a source data to output a binary string;
outputting side information according to the source data;
buffering the binary string;
buffering the side information; and
converting the binary string to a bitstream with reference to the side information and outputting the bitstream.

11. The image encoding method according to claim 10, wherein the source data is encoded/compressed by pipelined scheduling to output the binary string; and the binary string is encoded to the bitstream by non-pipelined scheduling.

12. The image encoding method according to claim 10, wherein the side information comprises slice header information, picture parameter set information, and/or sequence parameter set information.

13. The image encoding method according to claim 10, wherein:
a motion vector of the source data is identified by block matching and the motion vector is encoded;
similarities between a plurality of macro blocks of the source data are searched, compared and eliminated by intra prediction;
an image frame is reconstructed; and
a mosaic noise in a reconstructed image frame is eliminated.

14. An image decoding method, comprising:
decoding a bitstream to a binary string and side information;
buffering the binary string;
buffering the side information; and
decoding the binary string with reference to the side information to generate an output image signal.

15. The image decoding method according to claim 14, wherein:
the binary string is decoded by pipelined scheduling; and
the bitstream is decoded to the binary string by non-pipelined scheduling.

16. The image decoding method according to claim 14, wherein the side information comprises slice header information, picture parameter set information, and/or sequence parameter set information.
